(19) United States
(12) Patent Application Publication
(10) Pub. No.: US 2011/0159967 A1
(43) Pub. Date: Jun. 30, 2011

(54) SCREENSPLITTER

(76) Inventor: Evalena Beisser, Whitehorse (CA)

(21) Appl. No.: 12/977,817

(22) Filed: Dec. 23, 2010

(30) Foreign Application Priority Data
Dec. 24, 2009 (CA) 2,688,824

(51) Int. Cl. A63F 13/00; B31F 5/02

(52) U.S. Cl. 463/47; 493/356

(57) ABSTRACT

A screensplitter for splitting a viewing screen of a gaming device which has a first opaque panel having a first end, a second end, and opposed edges and a second opaque panel having a first end, a second end, and opposed edges. Engagement means are provided for securing the first opaque panel to the second opaque panel at an angle with the first opaque panel being vertically offset from the second opaque panel. Securing means are also provided for attaching the first end of the first opaque panel and the second end of the second opaque panel to a viewing screen.

### BACKGROUND

The present invention relates to viewing screens, and in particular, screensplitters for viewing screens for video games.

Multiplayer video games are popular. A problem with playing video games set for multi-player setting of two players is that each player can see what the other player is doing which can limit game enjoyment. To enhance the experience, garners like to block an opponent's ability to view their portion of the viewing screen. Previously, in order to have a full game experience, each player would need to setup two screens with two separate game consoles. The expense would limit most garners due to cost constraints.

Screensplitters are known in the prior art. U.S. Patent Application 2008/0310018 A1 (Tripp) discloses a split screen apparatus and method which teaches a polarized split screen that requires a user be provided with corresponding polarized glasses in order to function. There are many drawbacks to this requirement as polarized glasses are expensive to manufacture, can be lost easily, may be uncomfortable for some players to wear, and can be a visual distraction during intense game play. Moreover, they may not be suitable for all types of gaming experiences as there are some games which require a user to wear game related goggles or headsets.

What is required is a simple, cost effective screensplitter for a television console or a flat screen.

### SUMMARY

There is provided a screensplitter for splitting a viewing screen of a gaming device which has a first opaque panel having a first end, a second end, a top edge and a bottom edge and a second opaque panel having a first end, a second end, a top edge and a bottom edge. Engagement means are provided for securing the second end of the first opaque panel to the first end of the second opaque panel at an angle with the first opaque panel being vertically offset from the second opaque panel. Securing means are also provided for attaching the first end of the first opaque panel and the second end of the second opaque panel to a viewing screen.

Another aspect of the invention involves a method of splitting a viewing screen which includes several steps. One step involves providing a screensplitter for splitting a viewing screen of a gaming device. As described above, the screensplitter includes a first opaque panel with a first end, a second end, a top edge and a bottom edge and a second opaque panel with a first end, a second end, a top edge and a bottom edge. Another step involves engaging the second end of the first opaque panel to the first end of the second opaque panel at an angle with the first opaque panel being vertically offset from second opaque panel. Another step involves securing the screensplitter to a viewing screen of a gaming device.

Yet another aspect of the invention involves making a screensplitter from a substantially rectangular shaped opaque planar body. Cuts are made in the substantially rectangular shaped opaque planar body to define a first integrally formed opaque panel having a first end, a second end, a top edge and a bottom edge. Cuts are also made in substantially rectangular shaped opaque planar body to define a second integrally formed opaque panel having a first end, a second end, a top edge and a bottom edge. Cuts are also made in the substantially rectangular shaped opaque planar body to define interlocking engagement members which are used for securing the second end of the first opaque panel to the first end of the second opaque panel at an angle with the first opaque panel vertically offset from the second opaque panel.

Cuts are made in the substantially rectangular shaped opaque planar body to define at least one attachment hook for securing the substantially rectangular shaped opaque planar body to a viewing screen. By folding along a crease line at the first end of the first opaque panel and folding along a crease line at the second end of the second opaque panel, first opaque panel is angled and vertically offset from the second opaque panel. Interlocking engagement members can then be interlocked for engaging the second end of the first opaque panel to the first end of the second opaque panel. By folding along crease lines, the attachment hooks can be angled for hooking onto to a viewing screen.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a back view of a screensplitter.

FIG. 2 is a detailed exploded view of the securing tabs of a screensplitter.

FIG. 3 is a top plan view of the screensplitter secured to a viewing screen.

FIG. 4 is a detailed view of the screensplitter secured to the viewing screen.

FIG. 5 is front view of the screensplitter secured to a viewing screen.

FIG. 6 is a side elevation view of the screensplitter secured to a viewing screen.

FIG. 7 is top plan view of a player seating arrangement in relation to the screensplitter.

FIG. 8 is a front plan view of a screensplitter template for making a screensplitter.

FIG. 9 is a front view of a screensplitter.

FIG. 10 is a detailed from view of the attachment hooks.

FIG. 11 is a side elevation view of a screensplitter on with attachment hooks on a viewing screen.

### DETAILED DESCRIPTION

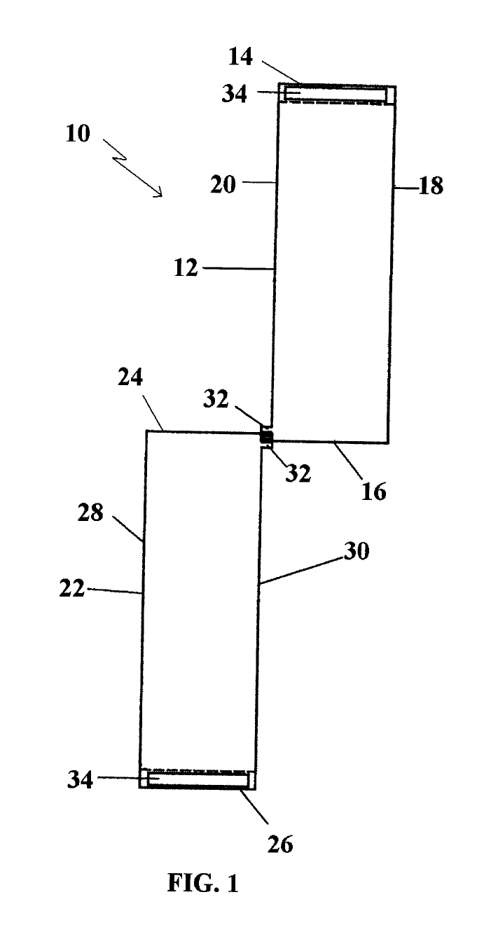

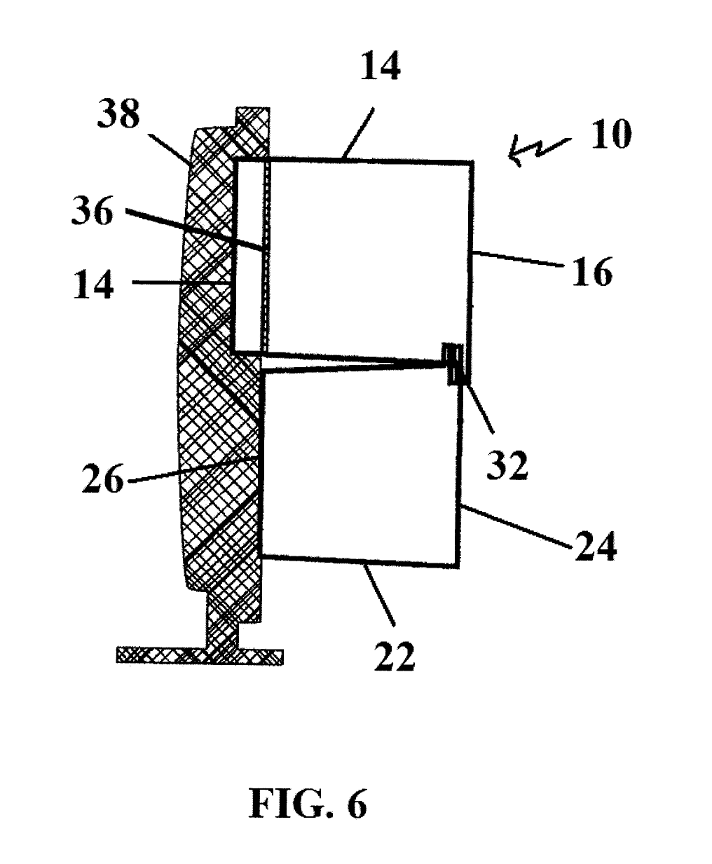

A screensplitter generally identified by reference numeral 10, will now be described with reference to FIG. 1 through 11.

Structure and Relationship to Parts:

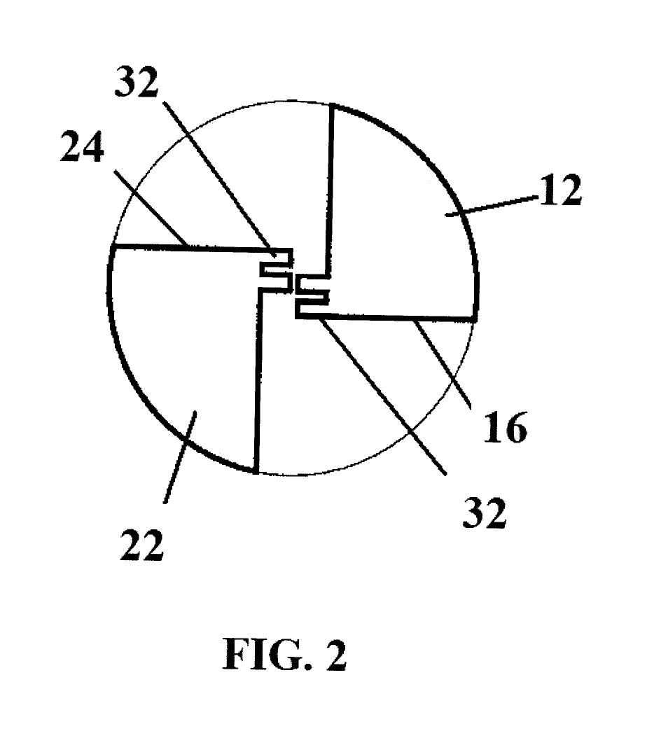

Referring to FIG. 1, there is provided a screensplitter 10 for splitting a viewing screen of a gaming device. Screensplitter 10 has a first panel 12 with a first end 14, a second end 16, a top edge 18 and a bottom edge 20. A second panel 22 is provided which also has a first end 24, a second end 26, a top edge 28 and a bottom edge 30. In the illustrated embodiment, first panel 12 and second panel 22 are opaque, however it will be appreciated that first panel 12 and second panel 22 could also be translucent. Interlocking engagement members 32 are provided for securing second end 16 of first opaque panel 12 to first end 24 of second opaque panel 22 at an angle with first opaque panel 12 being vertically offset from second opaque panel 22. Referring to FIG. 2, in the illustrated embodiment, interlocking engagement members 32 are integrally formed with first opaque panel 12 and second opaque panel 22.

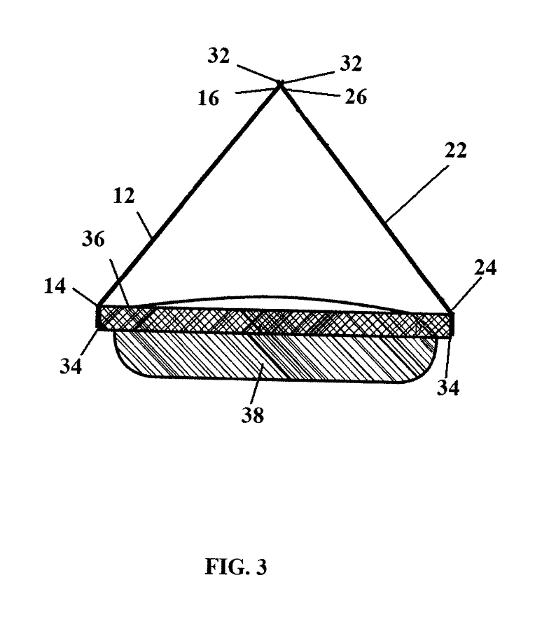

Referring to FIG. 1, essentially, first opaque panel 12 and second opaque panel 22 are identical and in use, first opaque panel 12 is merely rotated 180 degrees as shown in FIG. 3.

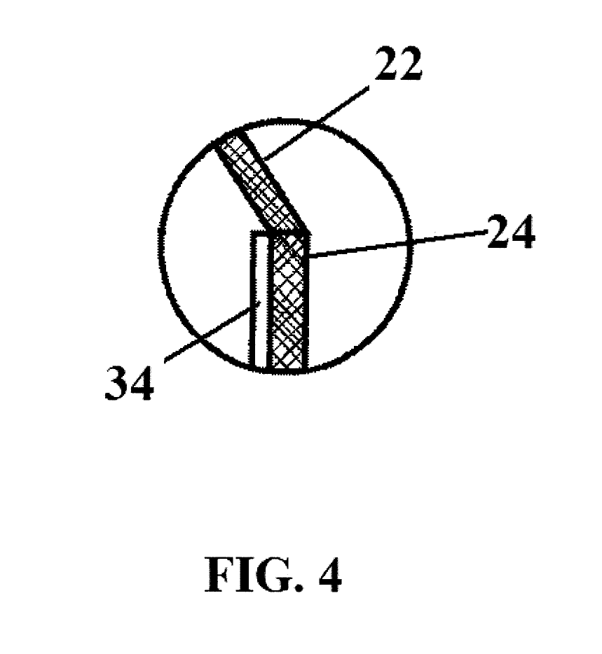

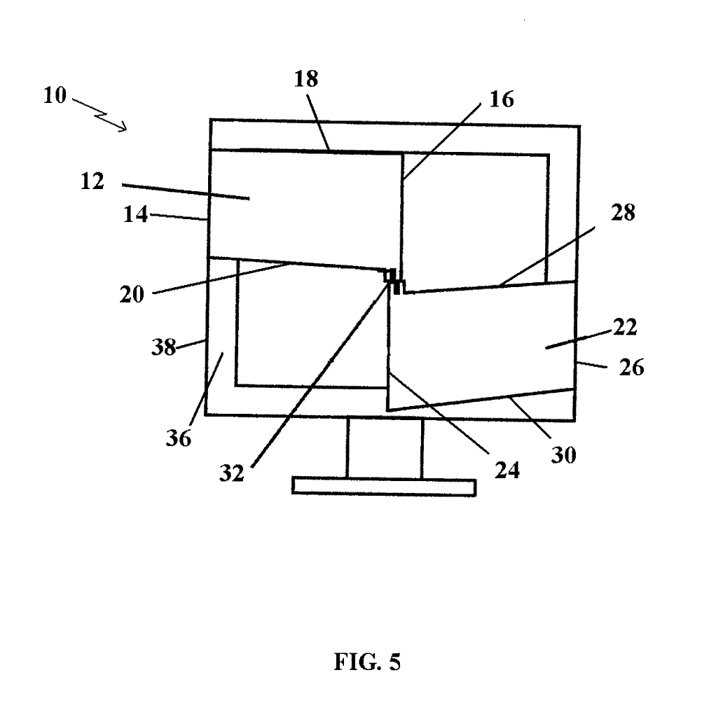

Referring to FIG. 1, mating tape 34, such as Velcro™ tape is used for attaching first end 14 of first opaque panel 12 and second end 26 of second opaque panel 12 to a viewing screen 36 of a gaming device 38 as shown in FIG. 3, FIG. 4 and FIG. 5.

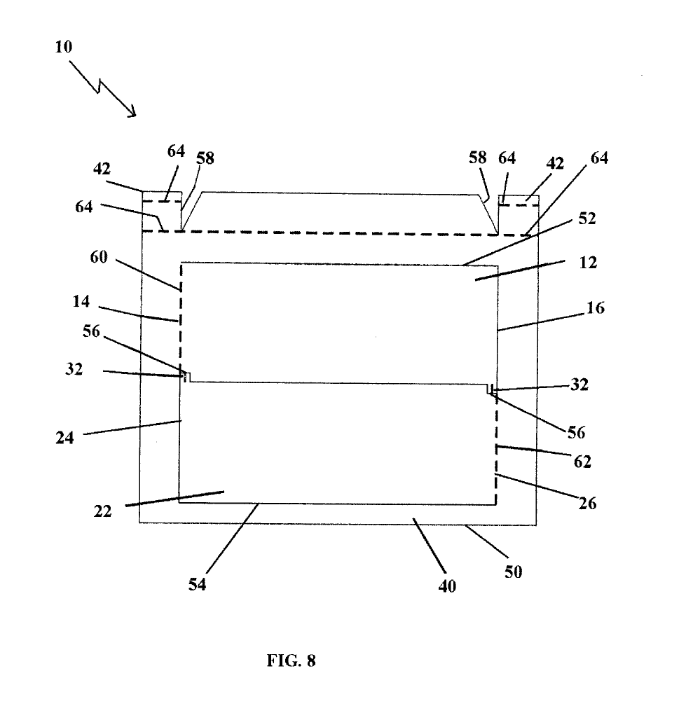

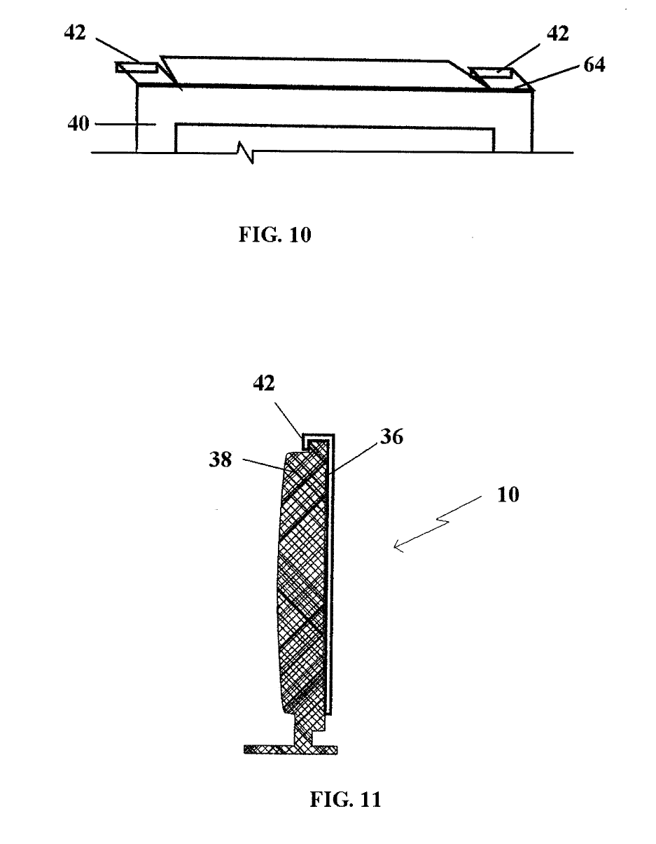

Referring to FIG. 8, alternatively, first opaque panel 12 and second opaque panel 22 can have an integrally formed circumferential frame 40 with mating tape 34 for attaching screensplitter 10 to a viewing screen 36. In the alternative, attachment hooks 42 can also be used as shown in FIGS. 10 and 11.

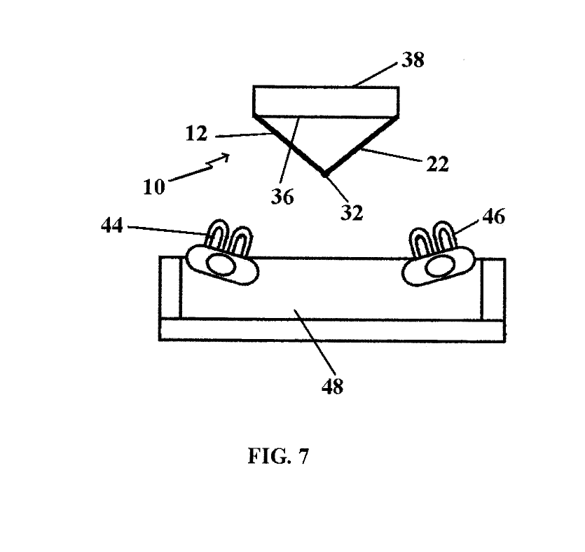

Referring to FIG. 7, screensplitter 10 is an attachment that enhances game play viewing for two players 44 and 46 of multi-player games. Screensplitter 10 solves a problem of playing games set for multiplayer setting of two players. Previously, in order to have a full game experience each player would need to setup two screens with two separate game consoles. The expense would limit most garners due to cost constraints. However with the screen splitter of the present invention, the garners experience would be enhanced. Making it affordable with a simple setup of screensplitter 10 to gaming device 38 such as a television console or a flat screen. As shown in FIG. 7, one player 44 can be seated spaced from another player 46 on a sofa 48 or chairs, and both players 44 and 46 can play the same game on the same device 38, and yet be prevented from seeing the portion of the viewing screen 36 allocated to the other players game by the screensplitter 10.

In the illustrated embodiment shown in FIG. 5, screensplitter 10 includes two rectangular panels 12 and 22, of equal and identical shapes that are joined together with interlocking members 32. Screensplitter 10 is then either hung over a viewing screen 36 such as flat screen using attachment hooks 42 as illustrated in FIG. 11 or attached to viewing screen 36 using mating tape 34 such as Velcro™ strips which are fastened and secured to fit a particular viewing screen size as illustrated in FIGS. 3 and 4.

Any number of rigid flat materials could be employed for screensplitter 10, such as; card board or thin plastic sheets which can be cut to fit any standard sizes of viewing screens 36 such as television screens or flat screen monitors. Referring to FIG. 4 and FIG. 7, panels 12 and 22 are fastened such that each player 44 and 46 may view his own game screen and yet is prevented (blocked) from viewing his opponents screen. The present invention is a product to enhance garners' experience, such as X-Box™, PS2™ garners view by blocking opponents' view of one screen over the other while maintaining viewing of the other.

Operation

Referring to FIG. 1 through FIG. 11, there is illustrated a method of splitting a viewing screen comprising several steps. One step involves providing screensplitter 10 for splitting viewing screen 36 of gaming device 38. As described above, screensplitter 10 includes first opaque panel 12 with first end 14, second end 16, top edge 18 and bottom edge 20 and second opaque panel 22 with first end 24, second end 26, top edge 28 and bottom edge 30. Another step involves engaging second end 16 of first opaque panel 12 to first end 24 of second opaque panel 22 at an angle with first opaque panel 12 being vertically offset from second opaque panel 22. Another step involves securing screensplitter 10 to viewing screen 36 of gaming device 38.

Referring to FIG. 7, once screensplitter 10 is properly secured, one player 44 can be seated spaced from another player 46 on a sofa 48 or chairs, and both players 44 and 46 can play the same game on the same device 38, and yet each player is prevented from seeing the portion of viewing screen 36 featuring the other player's game by the screensplitter 10.

Referring to FIG. 8 through FIG. 11, there is illustrated a method of making a screensplitter 10 for splitting a viewing screen of a gaming device which includes several steps.

Referring to FIG. 8, screensplitter 10 can be made from a substantially rectangular shaped opaque planar body 50. Cuts 52 are made in substantially rectangular shaped opaque planar body 50 to define first integrally formed opaque panel 12 which has first end 14, second end 16, top edge 18 and bottom edge 20. First end 14 remains integral formed with rectangular shaped opaque planar body 50. Cuts 54 are also made in substantially rectangular shaped opaque planar body 50 to define second integrally formed opaque panel 22 which has first end 24, second end 26, top edge 28 and bottom edge 30. Second end 26 remains integrally formed with rectangular shaped opaque planar body 50. Cuts 56 are also made in substantially rectangular shaped opaque planar body 50 to define interlocking engagement members 32 for securing second end 16 of first opaque panel 12 to first end 24 of second opaque panel 22 at an angle with first opaque panel 12 being vertically offset from second opaque panel 22. Cuts 58 are made in substantially rectangular shaped opaque planar body 50 to define attachment hooks 42 for securing substantially rectangular shaped opaque planar body 50 to viewing screen 36. Cuts 52 and 54 also serve to define a circumferential frame 40.

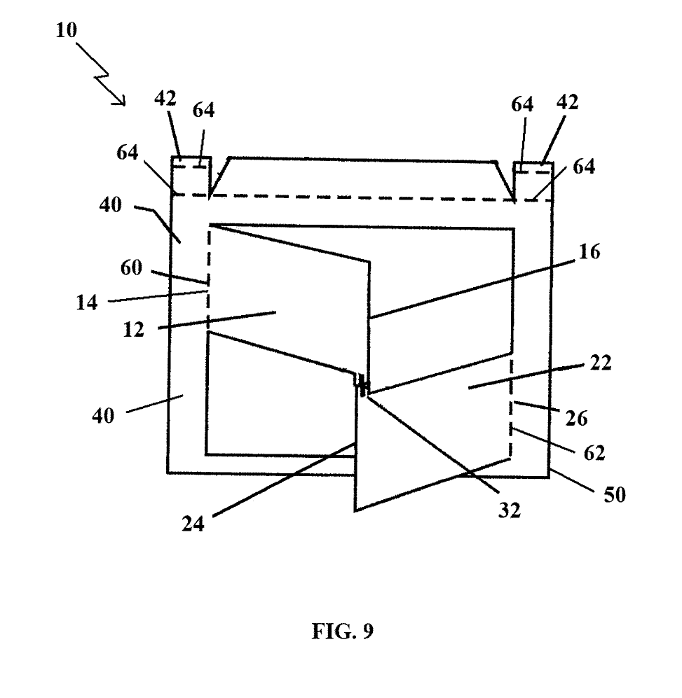

Referring to FIG. 9, by folding along a crease line 60 at first end 12 of first opaque panel 12 and folding along a crease line 62 at second end 26 of second opaque panel 22, first opaque panel 12 and second opaque panel 22 can be angled outwardly. First opaque panel 12 will be vertically offset from second opaque panel 22. Interlocking engagement members 32 can then be interlocked for engaging second end 16 of first opaque panel 12 to first end 24 of second opaque panel 22. Referring to FIGS. 10 and 11, by folding along crease lines 64, attachment hooks 42 can be angled for attachment to viewing screen 36. Alternative means can be used for securing screensplitter 10 to viewing screen 36 such as mating tape as shown in FIG. 4.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A screensplitter for splitting a viewing screen of a gaming device, comprising;
a first panel having a first end, a second end, and opposed edges;
a second panel having a first end, a second end, and opposed edges;
engagement means for securing the first panel to the second panel at an angle with the first panel being vertically offset from the second panel; and
securing means for attaching the first end of the first panel and the second end of the second panel to a viewing screen wherein, when installed the screen splitter prevent each user from readily viewing the portion of the screen allocated to another user.

2. The screensplitter of claim 1 wherein the first panel and the second panel are opaque.

3. The screensplitter of claim 1 wherein the engagement means for securing the first panel to the second panel are interlocking engagement members positioned at the second end of the first panel and the first end of the second panel.

4. The screensplitter of claim 3 wherein the interlocking engagement members are integrally formed with the first panel and the second panel.

5. The screensplitter of claim 1 wherein the securing means for attaching the first end of the first panel and the second end of the second panel to a viewing screen is mating tape.

6. The screensplitter of claim 1 wherein the securing means for attaching the first end of the first panel and the second end of the second panel to a viewing screen is an integrally formed circumferential frame with mating tape.

7. The screensplitter of claim 1 wherein the securing means for attaching the first end of the first panel and the second end of the second panel to a viewing screen is at least one attachment hook.

8. A method of splitting a viewing screen comprising the following steps;
providing a screensplitter for splitting a viewing screen of a gaming device, the screen splitter having a first panel with a first end, a second end, and opposed edges and a second panel with a first end, a second end, and opposed edges;
engaging the first panel with the second panel at an angle with the first panel being vertically offset from second panel; and
securing the screensplitter to a viewing screen.

9. The screensplitter of claim 8 wherein the first panel and the second panel are opaque.

10. A method of making a screensplitter for splitting a viewing screen of a gaming device, comprising the following steps;
providing a substantially rectangular shaped planar body,
making cuts in the substantially rectangular shaped planar body to define a first integrally formed panel having a first end, a second end, and opposed edges;
making cuts in the substantially rectangular shaped planar body to define a second integrally formed panel having a first end, a second end, and opposed edges;
making cuts in the substantially rectangular shaped planar body to define interlocking engagement members for securing the second end of the first panel to the first end of the second panel at an angle with the first panel vertically offset from the second panel;
making cuts in the substantially rectangular shaped planar body to define at least one attachment hook for securing the substantially rectangular shaped planar body to a viewing screen;
folding along a crease line at the first end of the first panel and folding along a crease line at the second end of the second panel such that first panel is angled and vertically offset from the second panel;
engaging the second end of the first panel to the first end of the second panel y means of the interlocking engagement members; and
folding along at least one crease line to angle the at least one attachment hook for attachment to a viewing screen.

11. The screensplitter of claim 10 wherein the first panel and the second panel are opaque.
